(19) United States
(12) Patent Application Publication
(10) Pub. No.: US 2017/0193454 A1
(43) Pub. Date: Jul. 6, 2017

(54) SIMPLIFIED AND SECURE EMPLOYMENT FORM COMPLETION

(71) Applicant: What Tax Form, LLC, San Diego, CA (US)

(72) Inventor: Emily Rotolo, San Diego, CA (US)

(73) Assignee: What Tax Form, LLC, San Diego, CA (US)

(21) Appl. No.: 15/399,167

(22) Filed: Jan. 5, 2017

Related U.S. Application Data
(60) Provisional application No. 62/274,853, filed on Jan. 5, 2016.

(51) Int. Cl. G06Q 10/10

(52) U.S. Cl. CPC G06Q 10/1053; G06Q 2220/10

(57) ABSTRACT

A server may securely transmit questions, which may include explanations of how to answer the question, to an employee operated computing device. Responses to the questions may be transmitted from the employee operated computing device to the server. The server may then store the responses in a secure database. The responses may be used to complete a tax form that is presented to the individual using the employee operated computing device. If accurate, an electronic signature may be applied to the tax form and the tax form may be retained in an electronic document repository. An employer operated computing device may access the electronic document repository, but may not be permitted to access the responses stored in the secure database.

### CROSS-REFERENCE TO RELATED APPLICATIONS

This application claims the benefit of U.S. provisional patent application No. 62/274,853, entitled “A COMPUTER ASSISTED METHOD TO GENERATE TAX FORMS,” filed on Jan. 5, 2016, which is incorporated herein by reference.

### FIELD OF INVENTION

The present invention relates to the completion of forms related to employment. More particularly, the present invention relates to the simplified, convenient, and secure completion of tax forms, benefit enrollment forms, and other forms required for employees and independent contractors prior to commencing work.

### BACKGROUND AND DESCRIPTION OF THE RELATED ART

The paperwork associated with an employee starting a new job is an impediment to hiring experienced by both the prospective employee and the prospective employer. Much of this paperwork is tax forms, for example used to determine the appropriate amounts to be withheld from an employee's paycheck for tax payments, but a variety of forms are typically required for governmental reporting, benefits enrollment, and even payroll purposes. Such forms, especially tax forms, are invariably difficult for most employees to understand, and are often likewise difficult for employers (or the representative of an employer) to understand. Even if an employer better understands the information required by a tax form, however, liability associated with giving an employee what could be construed as tax advice may preclude the employer from providing assistance to an employee. Moreover, even the straightforward aspects of employment forms, such as the employee's name, may be repeated on multiple forms (for example, on both a W-4 and an I-9), causing frustration for an employee who must write the same information multiple times—a waste of both time and energy, as well as opportunities to introduce unintentional errors or inconsistencies. While the situation may be somewhat simplified with independent contractors instead of employees, there are still often a multitude of confusing, redundant forms to complete that stand as a practical barrier to beginning new work.

### SUMMARY OF THE INVENTION

Systems and methods in accordance with the present invention simplify the process of completing tax forms and other employment documents for both employees and employers. In accordance with the present invention, information required across multiple forms may be entered a single time and automatically propagated across the relevant fields for all the needed forms. Further, in accordance with the present invention guidance, explanation, and/or advice may be provided to the employee completing a form without requiring that such advice originate from the prospective employer. The present invention may protect the privacy of employees by limiting the employer's access to only completed forms, rather than permitting an employer to access all of the information collected by a system and/or method in accordance with the present invention as part of the preparation of the forms, thereby exposing no more employee information to an employer than would be the case for forms completed with pen and paper. Further, systems and methods in accordance with the present invention may permit an employee to electronically sign a form, if a signature is required, thereby eliminating the need for paper in the employment form completion process entirely. In addition to reducing the environmental impact of printing paper forms, systems and methods in accordance with the present invention enable employers and employees to complete employment forms at locations other than a traditional office setting, such as at job sites that may be remote or inhospitable.

In some examples of systems in accordance with the present invention, one or more server may securely communicate with one or more employee operated computing device over at least one network. Communications between the at least one server and the employee operated computing device may be secured using encryption technologies used in conjunction with various communication protocols, such as TCP/IP protocols, to exchange packets across a network. Communications may occur between a server(s) and an employee operated computing device(s) over the Internet, an intranet, a local area network (“LAN”), a wide area network (“WAN”), or any other type of network or combination of networks. Communication protocols such as, but not limited to, TCP/IP may be used to transfer communications between the server(s) and employee operated computing device(s). The physical medium or media used to transmit communications between the server(s) and employee operated computing device(s) may comprise radio signals (such as are used for various 802.11 standards or for cellular communications with “smart phones”), fiber optics, Ethernet, or any other type of wired or wireless medium, or any combination of mediums.

The employee operated computing device(s) of exemplary systems in accordance with the present invention may comprise a device owned by the individual employee (or independent contractor, but generally referred to as “employee” herein for brevity), but in other examples may comprise a device provided by an employer to the employee for his or her use in the practice of methods in accordance with the present invention. In yet further examples, an employee operated computing device may comprise a device provided by a third party. The server may securely transmit a series of questions or requests to the employee operated computing device, and the employee operated computing device may communicate those requests, which may also contain explanations of the requests, to the employee using a screen or other display device, a speaker, a printer, or any other type of output mechanism. The employee operating the computing device may enter appropriate responses to the questions or requests using one or more input device that provides user inputs to the employee operated computing device. For example, an employee may use a keyboard, a mouse, a touch sensitive screen, a microphone, or any other input mechanism to provide responses to the requests. A user interface may facilitate the communication of requests and the receipt of responses by providing text fields, drop-down menus, or other data collection interfaces. The user interface(s) may be provided within a web browser operating on the employee operated computing device, but in other examples may be provided using a program or application operating on the employee operated computing device that is devoted partially or entirely to systems and methods in accordance with the present invention. The responses provided by the employee using the employee operated computing device may be securely transmitted to the server for further use in accordance with the present invention.

The server may securely access an encrypted database to store the employee provided response(s) and/or information contained in those response(s). The responses received by the server may be retained upon the server itself only in a transient fashion until those responses are stored, either permanently or temporarily, in the encrypted database and/or until the information/response(s) are used to populate the fields in one or more form. The server may generate completed forms, such as tax forms or other employment related forms, by using the information provided in the received responses to populate the appropriate fields of the forms. The completed forms may be presented to the employee by communicating the form to the employee operated computing device via a secure connection and, if the employee approves the form, the employee may be provided the opportunity to electronically sign the form using DocuSign or other electronic signature technologies. The signed form may be returned to the server via the secure connection, and the server may thereafter store the signed form in an encrypted repository of electronic documents logically and/or physically distinct from the encrypted database containing the response information provided by the employee and used to generate the form(s).

The electronic repository of documents may be accessible to an employer computing device(s), for example such that the employer may access and rely upon the completed forms for the administration of payroll taxes and/or various employee benefit programs. However, the secure encrypted database containing the employee response information may not be accessible by the employer operated computing device, thereby providing no greater access to employee information by the employer than would be attained using strictly paper forms, while providing a far simpler and more convenient process of completing the forms than would be the case using pen and paper.

In further examples, the present invention may comprise a method for completing employment forms to simplify the process for employees while protecting employee privacy. In such exemplary methods, a plurality of questions may be transmitted from at least one server to at least one computing device operated by an employee. The questions may be transmitted securely over one or more network to the employee operated computing device. A plurality of responses to the questions may be provided by the employee using the employee operated computing device. Those responses may be securely transmitted to the server. The server may store the responses (or the information contained in the responses) in an encrypted database while only retaining the responses/information transiently on the server itself. The server may use at least some of the responses provided by an employee to generate at least one form, such as a tax form, and may present the completed form to the employee over a secure connection using the employee operated a computing device. If the completed form is acceptable to the employee, the employee may provide an electronic signature on the form using the employee operated computing device, and then the completed and signed form may be securely transmitted back to the server. The server may then securely retain the at least one signed form in an electronic document repository. The electronic document repository may be accessible to an employer operated computing device(s). However, the secure database retaining the employee responses to the questions may not be accessible to the employer operated computing device in order to limit the information available to the employer to that which would be available if the form in question had been completed by the employee without the use of systems and/or methods in accordance with the present invention. In some examples, the employee who provided responses to the questions and who electronically signed a form may have limited access to the electronic document repository in order to view his or her completed forms, but in such a case the employee may not be provided access to forms that he or she did not sign, thereby protecting the privacy of other employees.

Systems and methods in accordance with the present invention may be used to conveniently complete a variety of forms related to employment. While in many examples described herein the forms in question relate to taxes, many other types of forms may be conveniently completed using systems and methods in accordance with the present invention. For example, health insurance plan participation/enrollment forms, retirement plan enrollment forms, disability insurance plan enrollment forms, healthcare savings account enrollment forms, and a variety of other forms may be completed using systems and methods in accordance with the present invention.

In yet further examples, systems and methods in accordance with the present invention may be used to facilitate the training and/or onboarding process for new employees. For example, in many companies new employees must undergo various types of training or educational programming after hiring but before commencing work, and systems and methods in accordance with the present invention may be used to present such training to those employees and to collect information from a new employee attesting to his or her participation in such programs. In other examples, systems and methods in accordance with the present invention may pose questions to the employee requiring substantive responses to questions indicative of the individual's participation.

In addition to the exemplary systems and methods of the present invention described herein, the present invention may also comprise one or more computer readable media containing one or more set of instructions retained in a non-transitory form to cause one or more computer processor to operate to execute some or all of methods in accordance with the present invention. For example, non-transitory media may be provided to one or more server operating in accordance the present invention to cause the server to execute methods in accordance with the present invention. Further, in some instances computer readable media may be provided in conjunction with or as part of an employee operated computing device that may operate in conjunction with a server in accordance with the present invention. For example, an employee operated computing device may contain computer readable media containing computer readable instructions to cause the employee operated computing device to the collect information as described herein and complete any required forms at locations or under conditions where the employee operated computing device may lack network access required to communicate in real-time with the server. In such examples, responses and completed forms may be securely but temporarily retained on the employee operated computing device and may be transmitted to a server and, ultimately, a secure database (for the responses/information provided by the employee) and a secure electronic document repository (for the completed forms) after the employee operated computing device regains network access. Such an example may be particularly useful when employees are hired or onboarded in locations that are geographically remote or experiencing network or electrical outages due to natural disasters or other circumstances.

While described in examples herein, systems and methods in accordance with the present invention are not limited to any particular network configuration or type of computing device. Nor are systems and methods in accordance with the present invention limited to the completion of any particular form or type of form.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates an example of a system in accordance with the present invention;

FIG. 2 schematically illustrates a further example of a system in accordance with the present invention; and

FIG. 3 illustrates an example of a method in accordance with the present invention.

### DETAILED DESCRIPTION

Systems and methods in accordance with the present invention may query an employee or independent contractor (collectively referred to as an “employee” herein) for information relevant to one or more form and securely receive and store that information. Explanations or guidance in providing information optionally may be provided as part of the queries. Queries may originate at a server communicating with an employee operated computing device over a network, although in some examples the queries may originate at the employee operated computing device (particularly if the employee operated computing device temporarily lacks a network connection with the server). Information that may be used across many forms need only be provided a single time by an employee through the use of systems and methods in accordance with the present invention. The information received from the employee may be used to populate one or more form for signature by the employee. Completed and signed forms may be provided in a digital form to an employer for use in a human resources capacity. The employer's access to the information provided by an employee may be limited to the completed and signed forms, rather than extending to the underlying data used to populate the forms, thereby disclosing no more employee information to the employer than would be the case had the employee completed the form(s) using only pen and paper.

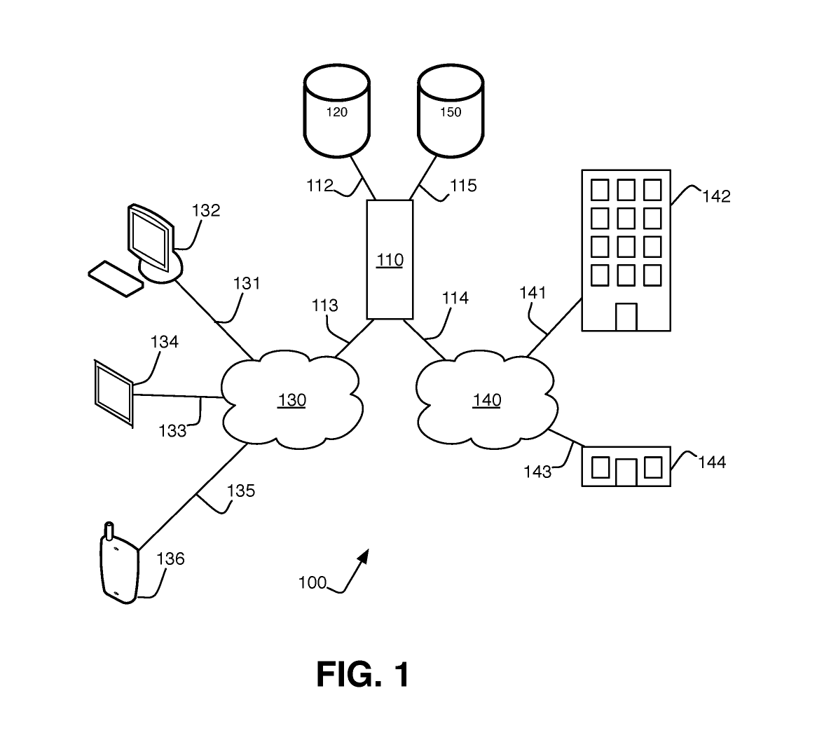

FIG. 1 depicts an exemplary system 100 in accordance with the present invention. At least one server 110 may connect 113 to one or more network 130 permitting communication with an employee operated computing device using a protocol such as TCP/IP. Sever 110 may securely communicate with one or more employee operated computing devices using encryption technologies. A variety of exemplary employee operated computing devices are depicted in the example of FIG. 1, although the present invention is not limited to any particular type of employee operated computing device or any particular number of employee operated computing devices that provide at least one computer processor, one or more input and output device to communicate information to a user and to receive user inputs, and a network connection. For example, an employee operated computing device may comprise a computing system 132 providing a monitor, keyboard, mouse, and/or other components such as may be found in a conventional desktop computer or laptop computer. The exemplary computing system 130 to may connect 131 to a network 130 in order to facilitate the secure exchange of information with server 110. By way of further example, an employee operated computing device may comprise a tablet computing device 134 connected 133 to network 130 to communicate with server 110. By way of further example, an employee operated computing device may comprise a smart phone 136 connected 135 to network 130 to communicate with server 110. While three examples of employee operated computing devices are shown in the example of FIG. 1, a variety of additional, alternative, or other types of employee operated computing devices may be used in conjunction with the present invention, such as, but not limited to, set-top boxes, virtual reality devices, or any other device capable of providing information to a user (such as in visual form, written form, or audible form) and receiving inputs from a user (such as in text form, touch form, or audible form). The connections between an employee operated computing device and a network may comprise any type of wired or wireless connection operating in accordance with any kind of protocol to permit the device in question to communicate with the server 110.

While depicted as a single network 130 in the example of FIG. 1, one or many networks may be used for communications between a server 110 and an employee operated computing device. In some examples, network 130 may comprise an intranet wholly or partially owned or operated by the employer, while in other circumstances network 130 may comprise a virtual private network that connects an employee operated computing device to a server 110 operated by third party providing systems and methods in accordance with the present invention. In yet further examples in accordance with the present invention, network 130 may comprise the Internet or a combination of the Internet, an intranet, a virtual private network, and/or other types of networks. As described in examples herein, server 110 may use an encryption technology to transmit a series of questions to an employee operated computing device. Similarly, the responses provided by the employee using the employee operated computing device may be encrypted for secure transmission to server 110. The responses and/or information contained in the responses received by the server 110 may be transmitted via a secure connection 112 from the server 110 to an encrypted database 120.

Server 110 may use the responses/information securely retained in encrypted database 120 to generate one or more form for signature by an employee operating a computing device. The employee may electronically sign a provided form if the form is accurate, and the server 110 may then securely retain the signed form in an electronic document repository 150. A computing device operated by the employer, such as at an employer headquarters 142 connected 141 to a network 140 or at an employer branch location 144 connected 143 to a network 140, may access completed and signed forms in the electronic document repository 150 for needed human resources purposes. As shown in the example of FIG. 1, a connection 141 to a network 140 may be used by the employer headquarters 142 to access the electronic document repository 150, while a branch office 144 may use a connection 143 to network 140 to access the document repository 150. However, more or fewer employer computing devices and/or locations may use more or different connections and/or networks to access the completed forms in the electronic document repository 150. Network(s) 140 may comprise the same or different network(s) 130 used for communications between the server 110 and an employee operated computing device. The electronic document repository 150 may be encrypted and may only permit authorized users/computing devices to access some or all of the documents within the repository 150.

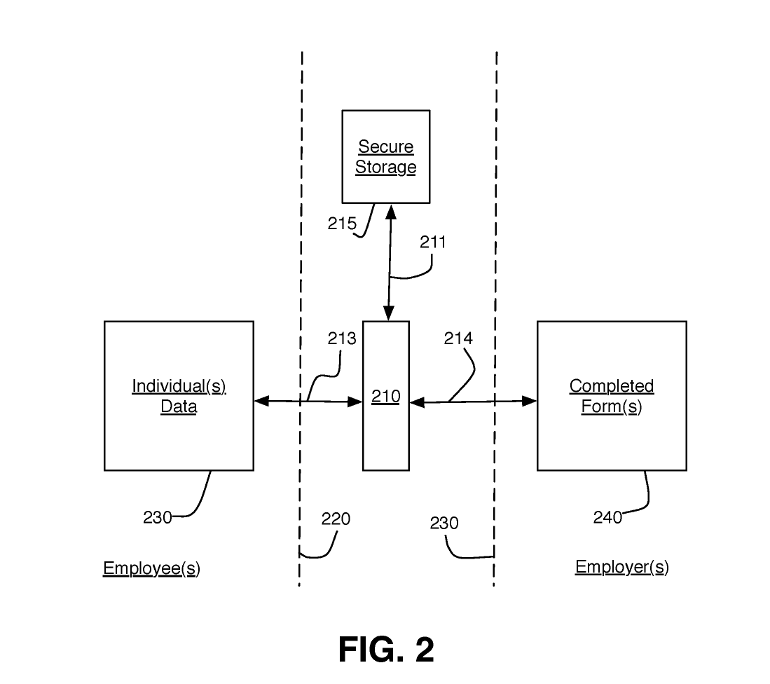

Referring now to FIG. 2, a further example of the systems and methods in accordance with the present invention is illustrated schematically. As can be seen in the example of FIG. 2, the present invention may be viewed as providing three logically distinct regions that may also comprise physically distinct regions. A logical separation 220 may divide an employee using systems and methods in accordance with the present invention from one or more server 210 and secure storage 215, although communication 213 may occur across the separation 220. Similarly, an employer may access completed forms 240 but may be otherwise logically separated 230 from the sever(s) 210 and secure storage 215. While limited and secured communications may cross the first logical divide 220 or the second logical divide 230, in some examples described herein a communication may only cross one of those divides, not both.

Individual data 230 may be collected using an employee operated computing device. Individual data 230 may correspond to a single employee or many employees, and it may be provided using the same or different computing devices. However, an individual employee may be limited to access data he or she inputted. In some examples, individual data 230 may be provided using one or more computing device provided to an employee by an employer, while in other examples individual data 230 may be provided using an individual's own computing device. In yet further examples, individual data 230 may be provided by a variety of computing devices, some provided by an employer for the use of an employee, some provided by employees themselves, some provided by third parties, or any other combination.

The individual data may be communicated 213 to a server 210, and server 210 may communicate 213 questions to an employee to collect the individual data 230. A logical and/or physical separation 220 may separate the individual data 230 from the server 210. In many examples of the separation 220 may be both physical and logical (such as when an employee operated computing device accesses a server in real time over a network connection), but in other examples the separation 220 may be initially logical (for example, when an individual at a location lacking network access completes forms by providing responses using an employer provided device at a location lacking network access) and may only later become a physical separation 220 (for example, when the provided device regains network access).

Still referring to the example of FIG. 2, a server 210 may access 211 secure storage 215 to retain records of individual information 230 provided 213 by employees. Secure storage 215 may comprise, for example, an encrypted database containing responses provided by individuals for use in completing forms, such as tax forms, and/or a secure document repository that retains wholly or partially completed forms. Secure storage 215 may comprise, for example, multiple databases and/or storage devices. Server 210 may use information contained in secure storage 215 previously received as individual data 230 to complete forms that may be placed in an electronic document repository accessible as completed forms 240 by an employer. In some circumstances, server 210 may permit access by an individual employee to his or her completed forms contained in the completed form(s) while preventing access to forms completed by others.

In some examples, server 210 may permit or require an individual employee to electronically sign a form before it is accessible by an employer.

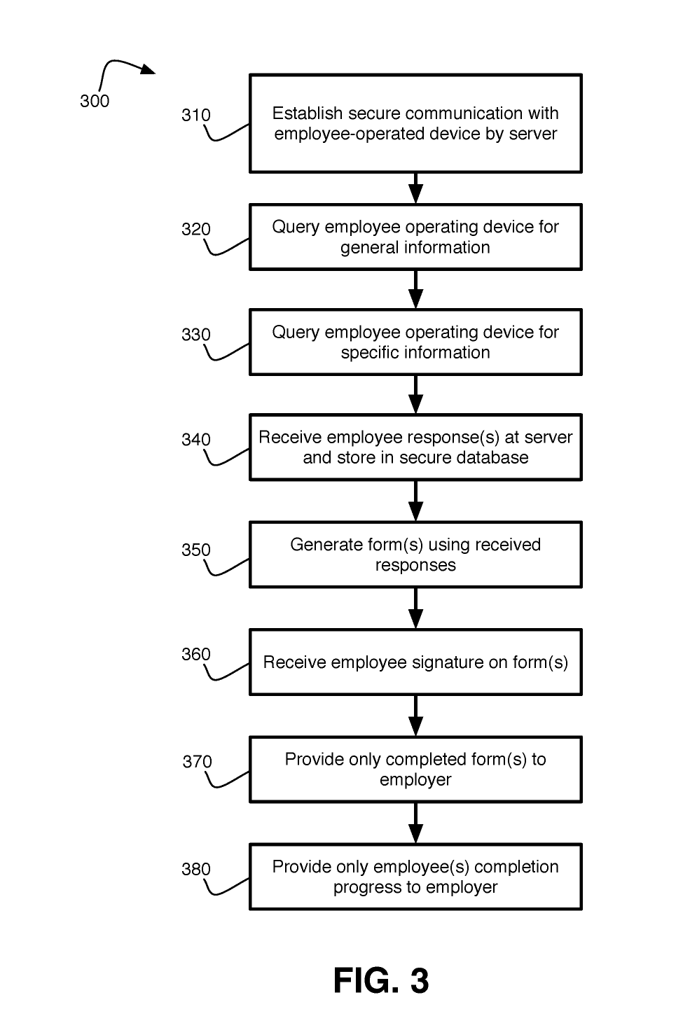

Referring now to FIG. 3, an example of a method 300 in accordance with the present invention is illustrated. The method 300 may operate, for example, in systems such as those depicted in the example of FIG. 1 and/or the example of FIG. 2, but method 300 and other methods in accordance with the present invention may operate on a variety of computing systems and/or using a variety of computer architectures beyond those described in the examples herein.

Method 300 may begin with a server establishing a secure communication with an employee operated computing device in step 310. Step 310 may operate over a single or multiple networks and may use a variety of communication protocols and/or encryption protocols to enable a secure connection. In step 320 the employee may be queried for general information. Step 320 may take the form of one or multiple communications between the server and the employee operated computing device. Step 320 may ask the employee to provide information such as his or her name, birth date, address, marital status, and/or other information pertinent to multiple forms. The queries transmitted to an employee in step 320 may be presented to an employee using an output device associated with an employee operated computing device in a variety of forms, such as using text, audio, visual representations, or through any other mechanism. In step 330, the employee may be queried for specific information, such as information required for a specific form. Step 330 may take the form of one or multiple communications between the server and the employee operated computing device. An example of specific information could be, for example, the designation of a beneficiary of a life insurance policy or a desired additional income tax withholding.

In step 340 the employee responses and/or information contained in those responses may be received and stored by the server(s). Step 340 may receive all responses to the queries made in step 320 and the queries made in step 330 simultaneously, but step 340 may additionally/alternatively comprise receiving a series of responses from the employee. The storage performed in step 340 may securely store the responses in an encrypted database that is not be accessible by the employer. In step 350 one or more form may be generated using the responses provided by the employee in step 340. The forms generated in step 350 may comprise, for example, tax forms such as a W-4 or an I-9, or any other type of employment form using the responses collected in response to the queries of step 320 and 330. The form(s) generated in step 350 may be presented to the employee (for example, by displaying the completed form on the screen of a computing device operated by the employee) and if the employee accepts the form the employee signature may be received in step 360. In step 370 only completed forms may be provided to an employer, for example by placing the completed form(s) in a secure electronic document repository accessible by the employer. Optionally, a method 300 in accordance with the present invention may provide completion progress of forms to an employer in step 380. Step 380 may be used, for example, to allow an employer to monitor the progress of employment related paperwork required by an employee prior to starting work without providing confidential information of the employee to the employer.

Systems and methods in accordance with the present invention may be implemented in a variety of computing environments on a variety of computing systems and/or using a variety of protocols. The architectures depicted herein are exemplary only, and systems and methods in accordance with the present invention may be implemented using different network architectures and/or computing devices than those described herein. Physical or “wet” signatures on a paper form may be received instead of electronic signatures as described in examples herein, but in many instances may comprise receiving an electronic signature from an employee using a computing device.

1. A system comprising:
a server accessible by an employee operated computing device over at least one network via an encrypted exchange of data packets, the server transmitting a series of questions to the employee operated computing device and receiving responses from an individual operating the client device;
an encrypted database securely accessible to the server, the encrypted database storing records of the responses received from the individual operating the client device; and
an encrypted repository of electronic documents populated using at least a portion of the responses received from the individual, the encrypted repository being accessible by an employer operated computing device and the encrypted database being inaccessible to the employer operated computing device.

2. The system of claim 1, wherein the encrypted repository of electronic documents comprises a plurality of tax forms.

3. The system of claim 2, wherein the server further receives an electronic signature of the employee using the employee computing device for at least one tax form in the repository of electronic documents before the tax form is placed in the repository of electronic documents.

4. The system of claim 3, wherein the records of the encrypted database contain more information than is required to complete any one of the tax forms retained in the electronic document repository.

5. The system of claim 4, wherein the series of questions transmitted from the server to the employee operated computing device comprise at least a first set of questions having general applicability to multiple tax forms and a second set of questions having specific applicability to a single tax form.

6. The system of claim 4, wherein the server transmits explanations with the first set of questions and the second set of questions, the explanations assisting the individual operating the employee operated computing device in providing a response to the questions.

7. The system of claim 6, wherein the employer operated computing device cannot access the encrypted database, the first set of questions, the second set of questions, and the explanations.

8. The system of claim 5, wherein the tax forms retained in the electronic document repository comprise PDF documents.

9. The system of claim 8, wherein the employer operated computing device cannot access a tax form within the repository of document until the employee has electronically signed the tax form.

10. A method for completing forms comprising:
transmitting a plurality of questions from at least one server to a computing device operated by an employee, the plurality of questions transmitted over at least one network in a securely encrypted format;
transmitting a plurality of responses to the plurality of questions from the computing device operated by the employee to the server, the plurality of responses transmitted over the at least one network in a securely encrypted format;
securely retaining the plurality of responses in a secure database accessible by the server;
using the plurality of responses, populating at least one tax form on behalf of the employee;
presenting the at least one tax form to the employee on the computing device operated by the employee over the at least one network in a securely encrypted format;
receiving an electronic signature from the employee on the at least one tax form presented; and
securely retaining the at least one tax form signed with an electronic signature in a repository accessible by an employer computing device, the employer computing device lacking access to the secure database retaining the plurality of responses.

11. The method of claim 10, wherein the plurality of questions transmitted from the at least one server to the computing device operated by an employee further comprise explanations of the questions.

12. The method of claim 11, wherein the plurality of questions transmitted from the at least one server to the computing device operated by an employee further comprise a first plurality of questions applicable to multiple tax forms and a second plurality of questions applicable to a single tax form.

13. The method of claim 12, further comprising transmitting from the server to the employer operated computing device a status indicator describing whether an employee has provided responses to questions without providing those responses in any form other than a completed and signed tax form contained within the depository.

14. The method of claim 12, wherein securely retaining the at least one tax form signed with an electronic signature in a repository accessible by an employer computing device further comprises retaining the at least one tax form signed with an electronic signature in the depository accessible by the employer computing device.

15. The method of claim 14, wherein the repository accessible by the employer computing device contains tax forms signed by multiple employers and an employer computing device may only access tax forms within the depository signed by the employee using the employee computing device.
